(19) United States
(12) Patent Application Publication
(10) Pub. No.: US 2014/0237891 A1
(43) Pub. Date: Aug. 28, 2014

(54) UNIVERSAL FISHING WEIGHT AND METHOD OF USE

(71) Applicant: Christopher Robert Donahoe, Roswell, GA (US)

(72) Inventor: Christopher Robert Donahoe, Roswell, GA (US)

(21) Appl. No.: 13/781,024

(22) Filed: Feb. 28, 2013

(51) Int. Cl. A01K 95/02; A01K 95/00

(52) U.S. Cl. CPC A01K 95/02; A01K 95/00
USPC 43/44.87

(57) ABSTRACT

A weight assembly for engagement with a fishing line, the assembly includes a first structure having a first structure contact surface, the first structure contact surface formed having a first set of two or more channels disposed in the first structure contact surface, a second structure having a second structure contact surface formed having a second set of two or more channels disposed in the second structure contact surface, wherein the first member contact surface of the first structure member is configured to engage the second structure contact surface, and wherein the first set of two or more channels disposed in the first structure contact surface and the second set of two or more channels disposed in the second structure contact surface are aligned to form two or more passageways therethrough and, functions to releasably affix to a fishing line as either a fixed sinker or as a sliding sinker.

### TECHNICAL FIELD

The disclosure relates generally to fishing weights for attachment to fishing line and more specifically it relates to fishing weights, sinkers, or knock weights used in conjunction with a fishing line and fishing lure or hook.

### BACKGROUND

Bottom fishing pertains to positioning the fish hook or fishing lure near the bottom of the fishing water where fish often pool and where fish tend to feed. The intent is to maintain the fishing line and bait on the water bottom while the bait or lure floats in the current. It is important to use the lightest sinker or weight but also one that is heavy enough to maintain the fishing line, hook and lure on the water bottom in a current or in deep water. Fish may be leery of over weighted fishing line, hook and lure and drop any bait that offers too much resistance. Moreover, too heavy of a sinker selection will prevent light striking fish from being noticed by the angler and the fish may strip the bait from the hook without the angler knowing that he had a bite.

Another variety of sinker is sliding or slip sinkers that slides along the fishing line. For example, when the fish takes the baited hook or lure, the fishing line passes through a hole in the sinker while the sinker stays on the water bottom. The slip sinker allows the angler to feel a nibble while permitting the fish to swim short distances from the sinker with the baited hook or lure without dragging the sinker along the water bottom, which can scare the fish or cause the fish to drop the baited hook or lure.

Various fishing weights, sinkers, or knock weights are known in the prior art, for example, there are fixed sinkers with a wire loop or hole to pass or tie fishing line therein, such as pyramid sinkers, bank sinkers, or pencil sinkers, and clamp or split-shot sinkers. Split-shot sinkers are small and round with a split cutting halfway through the sinker. The split can be placed on a piece of fishing line and then crimped closed with pliers to permanently secure the split-shot sinker to the fishing line.

To change fishing weights, sinkers, or knock weights, from a fixed sinker to a slip sinker or vice-a-versa the fishing line is either cut or disassembled to remove the current sinker and affix the other style of sinker followed by reassembly of the fishing line with a fish hook and bait or lure.

Therefore, it is readily apparent that there is a recognizable unmet need for a universal fishing weight and method of use, wherein a single fishing weight may be configured to releasably affix to a fishing line as either a fixed sinker affixed in position to a fishing line or as a sliding sinker capable of linear travel up and down a fishing line segment without cutting or disassembly of the fishing line.

### BRIEF SUMMARY

Briefly described, in example embodiment, the present apparatus overcomes the above-mentioned disadvantage, and meets the recognized need for universal fishing weight and method of use including, in general, a fishing weight having a two piece slip and or fixed sinker for use on fishing lines includes a two sectional sinker adapted to separate at a linear disposed, axial center, each sectional sinker having a surface, each surface having at least one surface of a pair of axial conduits positioned between the two sectional sinker to receive a fishing line. The two sectional sinker is maintained as a unitary sinker by magnetic attraction or forces therebtween, and, thus, functions to releasably affix to a fishing line as either a fixed sinker affixed in position to a fishing line or as a sliding sinker capable of linear travel up and down a fishing line segment without cutting or disassembly of the fishing line.

According to its major aspects and broadly stated, the universal fishing weight and method of use, includes in general, a fishing weight having a two piece slip and or fixed sinker for use on fishing lines includes a two sectional sinker adapted to separate at a linear disposed, axial center, each sectional sinker having a surface, each surface having at least one other surface of a pair of axial conduits positioned between the two sectional sinker, a slip resistant material positioned in one of the at least one other surface of one of the pair of axial conduits to receive a fishing line either pair of axial conduits as either a fixed sinker or a slip sinker.

In a preferred embodiment, a weight assembly for engagement with a fishing line, the assembly includes a first structure having a first structure contact surface, the first structure contact surface formed having a first set of two or more channels disposed in the first structure contact surface, a second structure having a second structure contact surface formed having a second set of two or more channels disposed in the second structure contact surface, wherein the first member contact surface of the first structure member is configured to engage the second structure contact surface, and wherein the first set of two or more channels disposed in the first structure contact surface and the second set of two or more channels disposed in the second structure contact surface are aligned to form two or more passageways therethrough.

In a further exemplary embodiment, a weight assembly for engagement with a fishing line, the assembly includes a first structure having a first structure contact surface, a second structure having a second structure contact surface formed having two or more channels disposed in the second structure contact surface, wherein the first member contact surface of the first structure member is configured to engage the second structure contact surface, and wherein the two or more channels disposed in the second structure and the first structure contact surface form two or more passageways therethrough.

In still a further exemplary embodiment of the method of releasably affixing a weight to a fishing line, the method includes the steps of providing a weight assembly that further comprises a first structure having a first structure contact surface, the first structure contact surface formed having a first set of two or more channels disposed in the first structure contact surface, a second structure having a second structure contact surface formed having a second set of two or more channels disposed in the second structure contact surface, wherein the first member contact surface of the first structure member is configured to engage the second structure contact surface, and wherein the first set of two or more channels disposed in the first structure contact surface and the second set of two or more channels disposed in the second structure contact surface are aligned to form two or more passageways therethrough, positioning the fishing line within one of the two or more passageways, aligning the a first set of two or more channels with the second set of two or more channels, and positioning the first structure contact surface of the a first structure in close proximity to the second structure contact surface of the second structure, wherein the first structure is releasably affixed to the second structure thereto the fishing line.

Accordingly, a feature of the universal fishing weight and method of use is its ability to provide a two-piece slip sinker that can be operatively attached to the fishing line without cutting or disassembly of the fishing line.

Another feature of the universal fishing weight and method of use is its ability to provide a two-piece slip sinker that can be operatively attached to the fishing line as a fixed sinker without cutting or disassembly of the fishing line.

Still another feature of the universal fishing weight and method of use is its ability to provide a two-piece slip sinker that can be operatively attached to the fishing line as a slip sinker without cutting or disassembly of the fishing line.

Yet another feature of the universal fishing weight and method of use is its ability to provide a two-piece slip sinker that can be operatively attached to the fishing line interchangeable from a fixed sinker to a slip sinker and vice-a-versa without cutting or disassembly of the fishing line.

Yet another feature of the universal fishing weight and method of use is its ability to provide a two-piece sinker that includes two detachable sections such as halves having a pair of axial through conduits centrally disposed between the halves as a pair of channel, one channel adapted to provide passage of the fishing line through the assembled slip sinker and the other channel adapted to prevent passage of the fishing line through the assembled slip sinker.

Yet another feature of the universal fishing weight and method of use is its ability to provide a two-piece sinker that includes two detachable sections such as halves, the two halves further include interlocking internal means to prevent interface rotation, slippage, or twisting of one half relative to the other half.

Yet another feature of the universal fishing weight and method of use is its ability to provide a two-piece sinker that includes two detachable sections releasably affixed one to the other by magnetism or magnetic forces.

Yet another feature of the universal fishing weight and method of use is its ability to provide a two-piece sinker that includes two detachable sections that can be dismantled without removing or disassembling any other parts.

Yet another feature of the universal fishing weight and method of use is its ability to provide a two-piece sinker that includes two detachable sections such as halves, the two halves further include a tab or indent to assist with separating one half from the other.

Yet another feature of the universal fishing weight and method of use is its ability to enable quick installation and removal from a fishing line.

Yet another feature of the universal fishing weight and method of use is its ability to line at least one channel with a slip resistant material to resist slipping or sliding of the fishing line through the fishing weight and to protect the fishing line integrity when positioned between two halves of the fishing weight.

Yet another feature of the universal fishing weight and method of use is its ability to provide a passageway with friction material positioned therein configured to provide a releasably fixed position fishing weight to a variety of circumference, diameter, and/or configured fishing line.

These and other features of the universal fishing weight and method of use will become more apparent to one skilled in the art from the Brief Description of the Drawings, Detailed Description, and Claims when read in light of the accompanying Drawings or Figures.

### BRIEF DESCRIPTION OF THE DRAWINGS

The present universal fishing weight and method of use will be better understood by reading the Detailed

Description of the embodiments with reference to the accompanying drawing figures, in which like reference numerals denote similar structure and refer to like elements throughout, and in which:

FIG. 1 is a perspective view of an example embodiment of the universal fishing weight assembly;

FIG. 2 is a perspective view of universal fishing weight assembly of FIG. 1, shown with a fishing line positioned in one of the two channels;

FIG. 3 is a perspective view of an alternate example embodiment of universal fishing weight assembly;

FIG. 4 is a perspective view of universal fishing weight assembly of FIG. 1, shown with a fishing line positioned in the slip channel of the two channels;

FIG. 5 is a perspective view of universal fishing weight assembly of FIG. 1, shown with a fishing line positioned in the fixed channel of the two channels; and

FIG. 6 is a flow diagram of a method of using the universal fishing weight.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

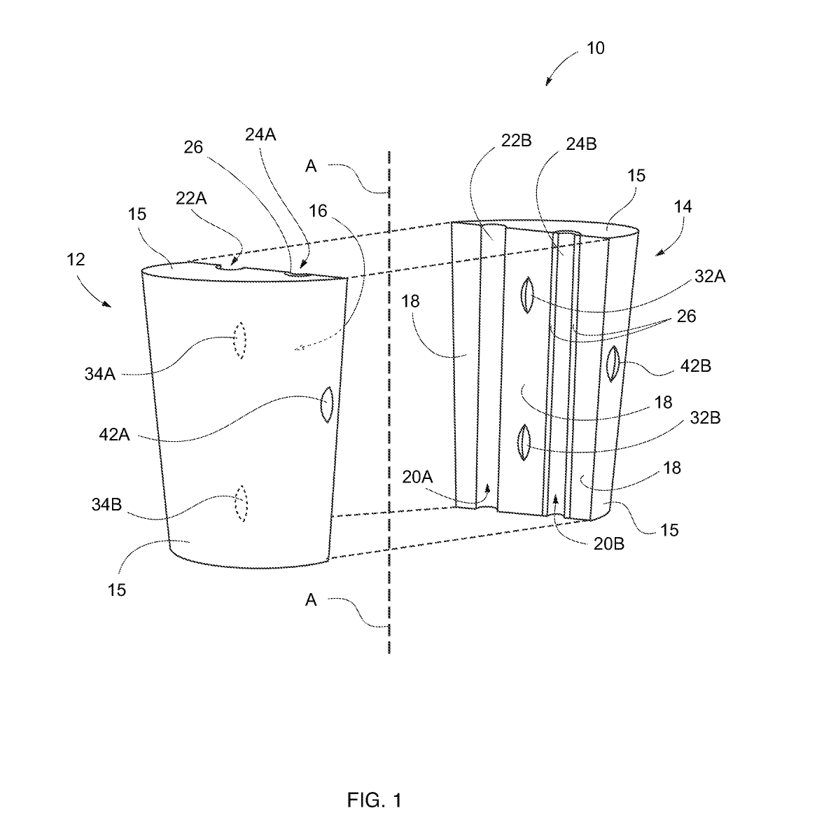

In describing the exemplary embodiments of the present disclosure, as illustrated in FIGS. 1-6 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIG. 1, by way of example, and not limitation, there is illustrated an example embodiment of universal fishing weight assembly 10. Preferably, universal fishing weight assembly 10 includes two or more piece, structure, component, or part, such as first structure 12 and second structure 14, shown displaced apart, and adapted to be separated and attached on axis or axial plane A. First structure 12 and second structure 14 of universal fishing weight assembly 10 preferably include one or more matching or mating structure surfaces, such as first structure contact surface 16 and second structure contact surface 18, and each surface is preferably adapted to contact and/or engage one another. Moreover, first structure contact surface 16 and second structure contact surface 18 preferably include two or more through openings, channels, or conduits, such as passageways 20A/20B.

Furthermore, first structure contact surface 16 and/or second structure contact surface 18 preferably include at least a portion of passageways 20A/20B at the axial separation of first structure 12 and second structure 14 of universal fishing weight assembly 10. Still further, first structure 12 and second structure 14 of universal fishing weight assembly 10 are preferably configured with matching or mating portions of channels, such as first channel 22 and second channel 24, such as first structure first axial channel 22A and first structure second axial channel 24A, and second structure first axial channel 22B and second structure second axial channel 24B; configured as first passageway 20A and configured as second passageway 20B, passing axially therethrough both first structure 12 and second structure 14 preferably where first structure contact surface 16 and second structure contact surface 18 meet or abut one another. Preferably, matching or mating first passageway 20A and second passageway 20B of first structure 12 and second structure 14 of universal fishing weight assembly 10 form the axial through openings through universal fishing weight assembly 10.

It is contemplated herein that first passageway 20A and second passageway 20B and/or channels 22 and channels 24 may be cross sectional configured as circular, square, curved, angled, or the like.

Universal fishing weight assembly 10, first structure 12 and second structure 14, first structure contact surface 16 and second structure contact surface 18 are preferably formed of one or more suitable materials, such as, magnet, magnetic material, materials that can be magnetized, ferromagnetic materials, electromagnet, metal, alloy, steel, iron, lead, rigid plastic or plastic with similar metal inserts, fiber, metal, aluminum, alloy, stainless steel, or the like, capable of providing structure to universal fishing weight assembly 10 or its parts. Preferably, the material includes other suitable characteristics, such as a magnetism or magnetic forces capable of providing sufficient attractive force to releasably hold or affix first structure 12 and second structure 14 together during use, magnetism or magnetic forces in combination with magnetically attracted material, durability, rust-resistance, oxidation resistance, ease of workability, or other beneficial characteristic understood by one skilled in the art.

Preferably, universal fishing weight assembly 10 includes one or more outwardly protruding alignment plugs 32, such as first alignment plug 32A and second alignment plug 32B attached to or protruding from second structure contact surface 18 and adapted to engage, oppositely placed but reversed configuration, and matching one or more inwardly concave or depression alignment holes 34, such as first alignment hole 34A and second alignment hole 34B. Alignment plugs 32 and alignment holes 34 preferably provide aligned engagement of first structure 12 and second structure 14 during use to prevent misalignment and maintain continuous axial alignment between first passageway 20A and second passageway 20B and/or planer slip or movement along the axial plane A between first structure and second structure 14, or first structure contact surface 16 and second structure contact surface 18.

It is contemplated herein that at least one of the two or more passageways 20A/20B is preferably adapted to enable universal fishing weight assembly 10 to freely slide along fishing line FL or enable fishing line FL to freely slide or slip therethrough first passageway 20A or second passageway 20B of universal fishing weight assembly 10.

It is contemplated herein that at least one of the two or more passageways 20A/20B is preferably adapted to be slip resistant, such as to receive a slip resistant material therein, such as friction material 26 positioned, for example, in at least a portion of one of the passageways, such as second passageway 20B. The friction material is any substance or compound as known in the art that will provide non-abrasive slip resistance under the circumstances described herein, such as being non-abrasive to fishing line FL so as not to break down the integrity of fishing line FL and/or preventing undesirable slippage or sliding fishing line FL in at least one of the two or more passageways 20A/20B, for exemplary purposes such material includes, and without limitation, silicone, polymer, rubber, or the like.

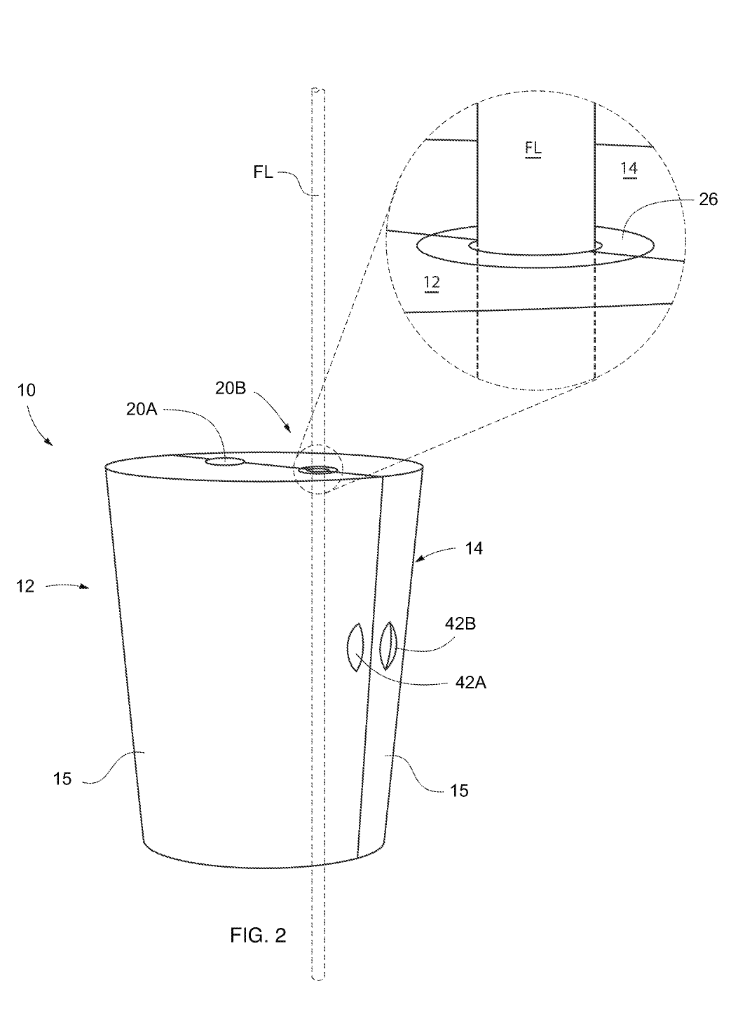

Referring now to FIG. 2, by way of example, and not limitation, there is illustrated an example embodiment of universal fishing weight assembly 10, shown in use. Universal fishing weight assembly 10 is shown releasably engaged, wrapped around, or assembled around the fishing line FL. In use to affix universal fishing weight assembly to fishing line FL, fishing line FL is preferably linearly aligned with one of first structure second axial channel 24A or second structure second axial channel 24B together configured as second passageway 20B and positioned therein. Next, the other of first structure second axial channel 24A or second structure second axial channel 24B together configured as second passageway 20B is preferably brought in close proximity to the other and magnetic forces between first structure 12 and second structure 14 of universal fishing weight assembly 10 attract one to the other to affix universal fishing weight assembly 10 thereto in fixed position on fishing line FL.

It is recognized herein that first structure 12 and second structure 14 of universal fishing weight assembly 10 may be difficult to separate or disengage due to their small size and/or due to the magnetic strength of the suitable material choice of first structure 12 and second structure 14, as such, first structure 12 and second structure 14 may preferably include one or more disengagement catches, indents, or protrusions, such as one or more disengagement tabs 42, more specifically first disengagement tab 42A and disengagement tab 42B, respectively positioned on exterior surface 15. First disengagement tab 42A and second disengagement tab 42B of first structure 12 and second structure 14 are preferably configured to provide leverage to separate magnetic engagement of first structure 12 from second structure 14.

In use to remove or reposition universal fishing weight assembly 10 on fishing line FL, universal fishing weight assembly 10 is preferably separated utilizing first disengagement tab 42A and second disengagement tab 42B to remove or release first structure 12 and/or second structure 14 of universal fishing weight assembly 10 one from the other and to remove or release universal fishing weight assembly 10 from fishing line FL.

It is recognized herein that first structure second axial channel 24A and second structure second axial channel 24B together configured as second passageway 20B and friction material 26 are configured to provide a releasably fixed position fishing weight to fishing line FL.

It is further recognized herein that first structure second axial channel 24A and second structure second axial channel 24B together configured as second passageway 20B may be sized to snuggly fit the circumference of fishing line FL to provide a releasably fixed position fishing weight to fishing line FL.

It is further contemplated herein that different types and sizes of fishing line FL vary in circumference, diameter, and/or configuration resulting in a variety of universal fishing weight assembly 10 with second passageway 20B configured to fit the circumference of fishing line FL. Alternatively, second passageway 20B with friction material positioned therein may be configured to provide releasably fixed position fishing weight to a variety of circumference, diameter, and/or configured fishing lines FL.

It is contemplated herein that at least one first passageway 20, such as second passageway 20B may be preferably sized to grip or affix thereto fishing line FL.

It is contemplated herein that at least one first passageway 20, such as first passageway 20A may be preferably sized to enable fishing line FL to slide or pass therethrough.

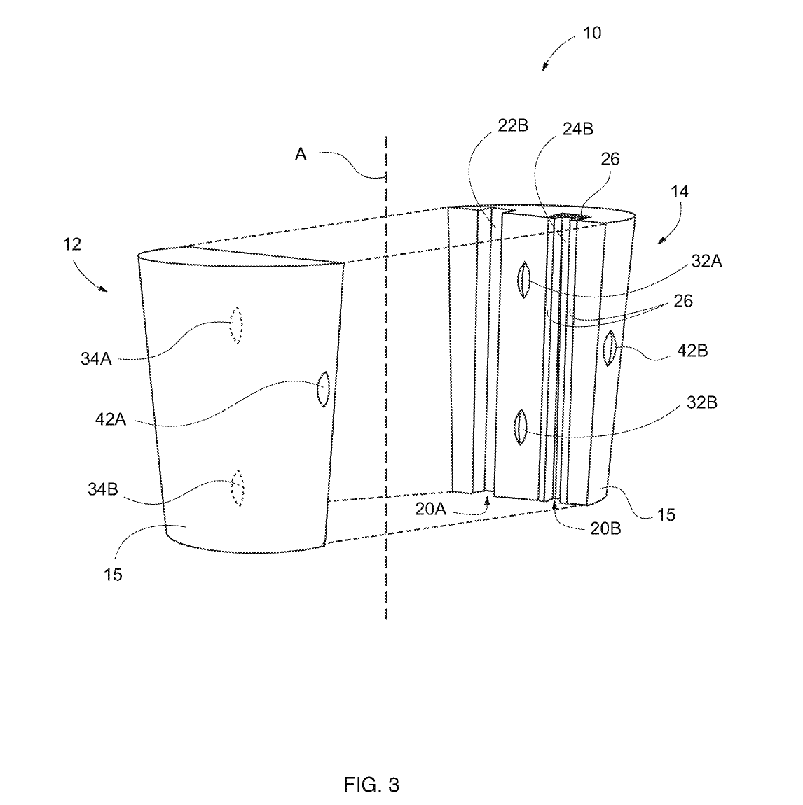

Referring now to FIG. 3, by way of example, and not limitation, there is illustrated an alternate example embodiment of universal fishing weight assembly 10. Preferably, universal fishing weight assembly 10 may be alternately configured wherein one or more of the two or more passageways 20A/20B is preferably configured having channels, such as first channel 22 and second channel 24 consolidated in one of first structure 12 or second structure 14 of universal fishing weight assembly 10. For example, second structure first axial channel 22B configured as first passageway 20A and second structure second axial channel 24B configured as second passageway 20B, passing axially therethrough second structure 14 preferably where first structure contact surface 16 and second structure contact surface 18 meet or abut one another and first structure contact surface 16 completes first passageway 20A second passageway 20B.

It is recognized herein that universal fishing weight assembly 10 may be configured without alignment plugs 32 and alignment holes 34, since aligned engagement of first structure 12 and second structure 14 may not be critical in this configuration.

It is contemplated herein that at least one of the two or more passageways 20A/20B is preferably adapted to receive a slip resistant material, such as friction material 26 positioned, for example, in at least a portion of second passageway 20B.

It is contemplated herein that universal fishing weight assembly 10 of FIG. 3 may be utilized as shown in FIG. 2.

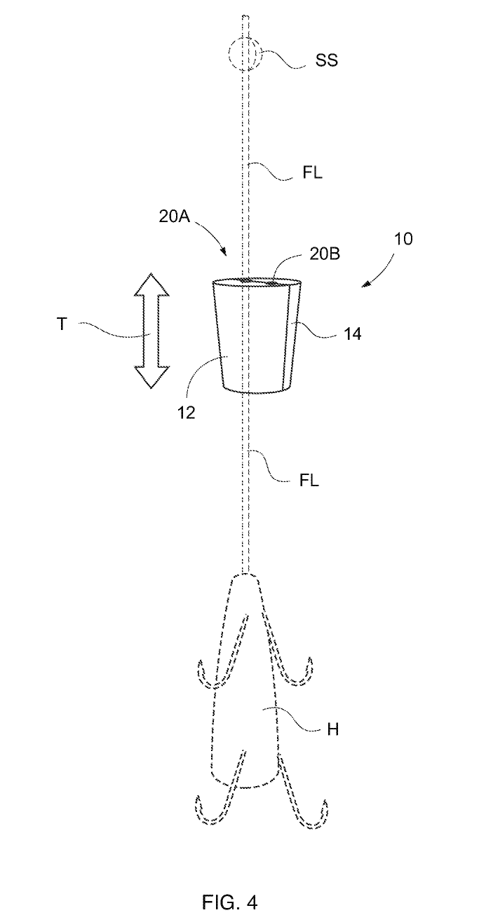

Referring now to FIG. 4, by way of example, and not limitation, there is illustrated an example embodiment of universal fishing weight assembly 10, shown in use. Universal fishing weight assembly 10 is shown releasably wrapped around, releasably affixed, or assembled around the fishing line FL. In use, to secure universal fishing weight assembly 10 to fishing line FL, fishing line FL is preferably linearly aligned and/or positioned with one of first structure first axial channel 22A or second structure first axial channel 22B together configured as first passageway 20A and positioned therein. Next, the other of first structure second axial channel 24A or second structure first axial channel 22B together configured as second passageway 20B is preferably brought in close proximity and/or aligned to the other and magnetic forces between first structure 12 and second structure 14 of universal fishing weight assembly 10 where magnetic attractive forces attract one to the other to secure universal fishing weight assembly 10 around fishing line FL.

In use to remove universal fishing weight assembly 10 on fishing line FL, universal fishing weight assembly 10 is preferably separated utilizing first disengagement tab 42A and second disengagement tab 42B (as shown in FIG. 1) to remove or release first structure 12 from second structure of universal fishing weight assembly 10 one from the other and to remove or release universal fishing weight assembly 10 from fishing line FL.

It is recognized herein that first structure first axial channel 22A and second structure first axial channel 22B together configured as first passageway 20A to provide a releasable sliding fishing weight to fishing line FL to enable fishing line FL to pass therethrough first passageway 20A and travel T up and down fishing line FL. For example, universal fishing weight assembly 10 may be utilized as a sliding or slip sinker that slides or travels T along the fishing line FL. For example, when the fish takes the baited hook or lure or hook H, the fishing line passes or travels T through first passageway 20A in universal fishing weight assembly 10 while universal fishing weight assembly 10 stays on the water bottom. Universal fishing weight assembly 10 allows an angler to feel a nibble while permitting the fish to swim short distances with the lure or hook H from universal fishing weight assembly 10 without dragging universal fishing weight assembly 10 along the water bottom, which can scare the fish or cause the fish to drop the lure or hook H.

It is contemplated herein that at least one first passageway 20, such as first passageway 20A may be preferably sized to enable fishing line FL to slide or pass therethrough or until universal fishing weight assembly 10 contacts, for example, stopper, clamp or split-shot sinker SS.

It is contemplated herein that universal fishing weight assembly 10 of FIG. 3 may be utilized as shown herein FIG. 4.

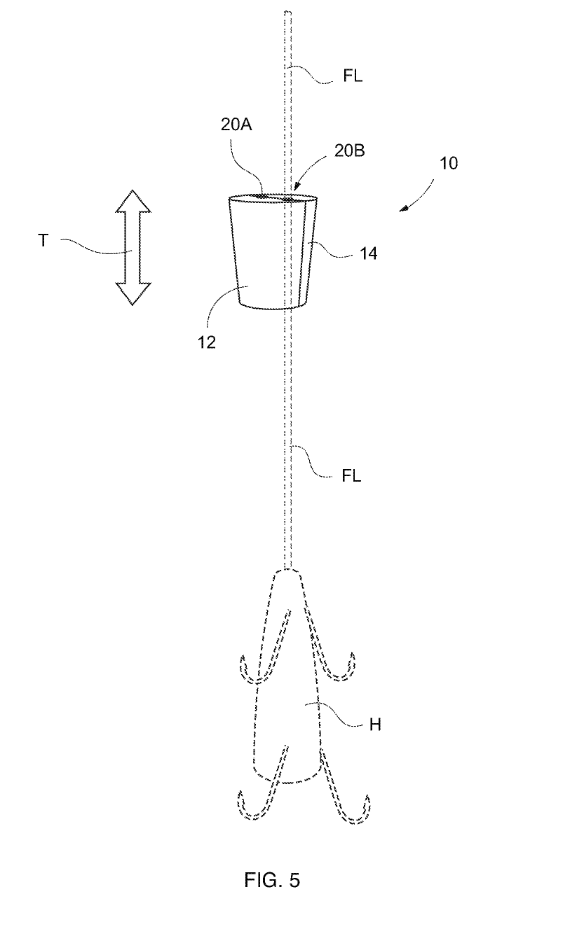

Referring now to FIG. 5, by way of example, and not limitation, there is illustrated an example embodiment of universal fishing weight assembly 10, shown in use. Universal fishing weight assembly 10 is shown releasably engaged, wrapped around, or assembled around the fishing line FL. In use to affix universal fishing weight assembly 10 to fishing line FL, fishing line FL is preferably linearly aligned and/or positioned with one of first structure second axial channel 24A or second structure second axial channel 24B together configured as second passageway 20B and positioned therein. Next, the other of first structure second axial channel 24A or second structure second axial channel 24B together configured as second passageway 20B is preferably brought in close proximity and/or aligned to the other and magnetic forces between first structure 12 and second structure 14 of universal fishing weight assembly 10 attract one to the other to releasably affix universal fishing weight assembly 10 thereto in a fixed position on fishing line FL.

It is recognized herein that first structure second axial channel 24A and second structure second axial channel 24B together configured as second passageway 20B and friction material 26 to provide a releasably fixed position fishing weight to fishing line FL.

It is further recognized herein that first structure second axial channel 24A and second structure second axial channel 24B together configured as second passageway 20B may be sized to snuggly fit the circumference of fishing line FL to provide a releasably fixed position fishing weight to fishing line FL without friction material 26.

It is contemplated herein that at least one first passageway 20, such as second passageway 20B may be preferably sized to releasably grip or affix thereto fishing line FL.

It is contemplated herein that at least one first passageway 20, such as first passageway 20A may be preferably sized to enable fishing line FL to slide or pass therethrough.

For example, universal fishing weight assembly 10 may be utilized as a fixed sinker that does not slide or travel T along the fishing line FL nor does the baited hook or lure or hook H connected thereto slide or travel T along the water bottom. For example, when the fish takes the baited hook or lure or hook H, the fish pulls fishing line FL and universal fishing weight assembly 10 along the water bottom.

It is contemplated herein that at least one first passageway 20, such as first passageway 20A may be preferably sized to enable fishing line FL to slide or pass therethrough or until universal fishing weight assembly 10 contacts, for example, stopper, clamp or split-shot sinker SS, as shown in FIG. 4.

It is contemplated herein that magnetic forces between first structure 12 and second structure 14 of universal fishing weight assembly 10 may utilize attachment devices, but is not limited to various attachment devices, such as threaded bolts, threaded carriage bolts, latch mechanisms, and the like and combinations thereof.

It is contemplated herein that first structure 12 and second structure 14 of universal fishing weight assembly 10 may have a configuration other than as shown, and is not limited to barrel shaped, such as globe, cone, pencil, round, elliptical shaped and the like and combinations thereof.

It is contemplated herein that sections or integral sections of first structure 12 and second structure 14 of universal fishing weight assembly 10 may include various configurations, number of, angles, curves and sizes.

It is contemplated herein that universal fishing weight assembly 10 of FIG. 3 may be utilized as shown herein FIG. 5.

It is contemplated herein that universal fishing weight assembly 10 may be configured with a single passageway, such as passageway 20B without passageway 20A. Preferably first structure axial channel 24A and second structure axial channel 24B are configured as single passageway 20B, passing axially therethrough both first structure 12 and second structure 14 preferably where first structure contact surface 16 and second structure contact surface 18 meet or abut one another, as shown in FIG. 1. Moreover, universal fishing weight assembly 10 may be configured with a single passageway, such as passageway 20B wherein second structure axial channel 24B configured as passageway 20B, passing axially therethrough second structure 14 preferably where first structure contact surface 16 and second structure contact surface 18 meet or abut one another and first structure contact surface 16 completes single passageway 20B, as shown in FIG. 3.

It is contemplated herein that single passageway 20B in the above is preferably adapted to be slip resistant, such as to receive a slip resistant material therein, such as friction material 26 positioned, for example, in at least a portion of single passageway 20B.

It is contemplated herein that single passageway 20B of universal fishing weight assembly 10 may be releasably engaged, wrapped around, or assembled around the fishing line FL, as shown in FIG. 5.

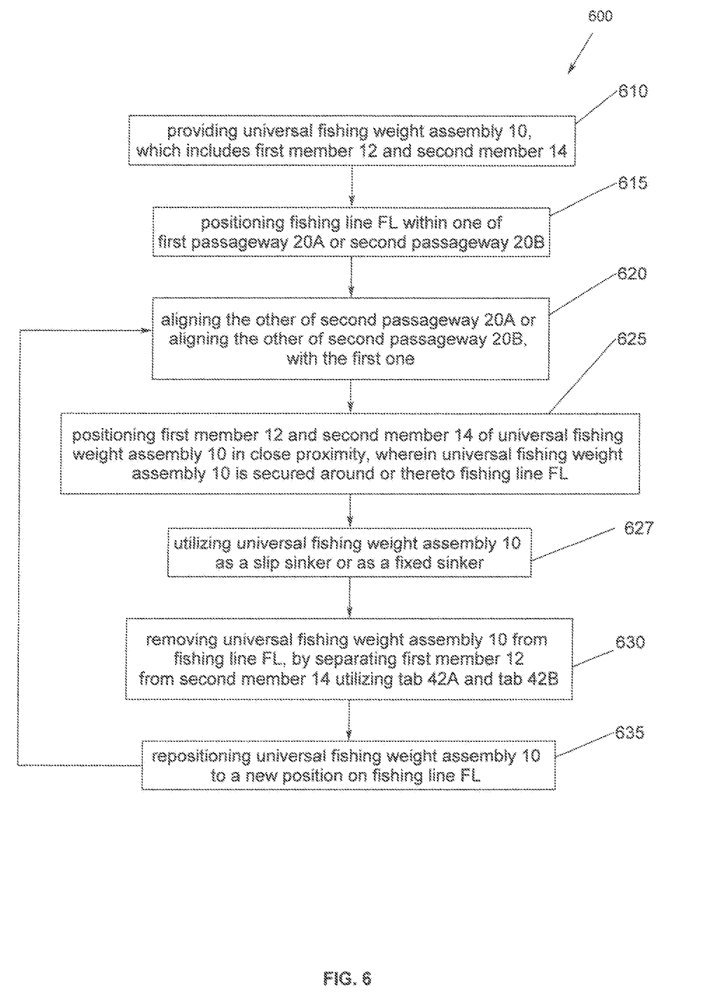

Referring now to FIG. 6, there is illustrated a flow diagram 600 of a method for releasably affixing a universal fishing weight to fishing line FL. In block or step 610, providing universal fishing weight assembly 10, which includes first structure 12 and second structure 14 as described above in FIGS. 1-5. In block or step 615, positioning fishing line FL within one of first structure first axial channel 22A or second structure first axial channel 22B together configured as first passageway 20A or positioning fishing line FL within one of first structure second axial channel 24A or second structure second axial channel 24B together configured as second passageway 20B. In block or step 620, aligning the other of first structure first axial channel 22A or second structure first axial channel 22B together configured as first passageway 20A, or aligning the other of first structure second axial channel 24A or second structure second axial channel 24B together configured as second passageway 20B, with the first one. In block or step 625 positioning first structure 12 and second structure 14 of universal fishing weight assembly 10 in close proximity, wherein attractive magnetic forces one to the other magnetically secure universal fishing weight assembly 10 around or thereto fishing line FL within first passageway 20A and second passageway 20B. In block or step 627 utilizing universal fishing weight assembly 10 on fishing line FL as a fixed sinker or a slip sinker. In block or step 630, removing universal fishing weight assembly 10 from fishing line FL. Universal fishing weight assembly 10 is preferably separated between first structure and second structure 14 utilizing first disengagement tab 42A and second disengagement tab 42B (as shown in FIG. 1) to remove or release first structure 12 and/or second structure 14 of universal fishing weight assembly 10 one from the other and to remove or release universal fishing weight assembly 10 therefrom fishing line FL. In block or step 635, universal fishing weight assembly 10 may be repositioned or moved to a new position on fishing line FL as set forth in block or steps 615, 620, 625, and 627.

The foregoing description and drawings comprise illustrative embodiments of the present invention. Having thus described exemplary embodiments, it should be noted by those ordinarily skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains having the benefit of the teachings presented in the foregoing descriptions and the associated drawings. Although specific terms may be employed herein, they are used in a generic and descriptive sense only and not for purposes of limitation. Moreover, the present invention has been described in detail; it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

1. A weight assembly for engagement with a fishing line, the assembly comprising:
a first structure having a first structure contact surface, said first structure contact surface formed having a first set of two or more longitudinally straight channels disposed in said first structure contact surface;
a second structure having a second structure contact surface, said second structure contact surface formed having a second set of two or more longitudinally straight channels disposed in said second structure contact surface, wherein said first structure contact surface of said first structure is configured to removeably engage said second structure contact surface;
wherein said first set of two or more channels disposed in said first structure contact surface and said second set of two or more channels disposed in said second structure contact surface are aligned to form two or more passageways therethrough;
wherein a first passageway of said two or more passageways is further configured to enable the fishing line to slide therethrough; and
wherein a second passageway of said two or more passageways is further configured having a friction material positioned therein to prevent the fishing line from sliding therethrough.

2. The weight assembly of claim 1, wherein said first structure contact surface abuts said second structure contact surface.

3. The weight assembly of claim 1, wherein said first structure contact surface abuts said second structure contact surface to form two or more passageways therethrough.

4. The weight assembly of claim 1, wherein said first structure and said second structure are releasably affixed one to the other.

5. The weight assembly of claim 4, wherein said releasably affixed further comprises magnetic forces.

6. The weight assembly of claim 1, wherein said first set of two or more channels disposed in said first structure contact surface and said second set of two or more channels disposed in said second structure contact surface are releasably displaced apart along an axial plane.

7. The weight assembly of claim 1, wherein said first structure contact surface further comprises one or more alignment plugs and said second structure contact surface further comprises one or more alignment holes configured to maintain alignment of said first set of two or more channels disposed in said first structure contact surface with said second set of two or more channels disposed in said second structure contact surface.

8. The weight assembly of claim 1, wherein one of said two or more passageways is further configured to enable the fishing line to slide therethrough.

9. (canceled)

10. The weight assembly of claim 1, wherein said friction material is selected from a group consisting of silicone, polymer, rubber and combinations thereof.

11. The weight assembly of claim 1, wherein said first structure and said second structure releasably affix one to the other via a magnetic force therebetween.

12. The weight assembly of claim 11, wherein said magnetic force is configured to releasably affix said first structure to said second structure in a fixed position on the fishing line.

13. The weight assembly of claim 12, wherein said second passageway and said friction material positioned therein are configured to releasably affix the fishing line therein.

14. The weight assembly of claim 11, further comprises two or more disengagement tabs configured to provide leverage to separate said first structure from said second structure.

15. The weight assembly of claim 14, wherein said two or more disengagement tabs are disposed on an exterior surface of said first structure and said second structure.

16. A weight assembly for engagement with a fishing line, the assembly comprising:
a first structure having a first flat structure contact surface, said first flat contact surface configured as a removeable cover;
a second structure having a second structure contact surface, said second structure contact surface formed having two or more longitudinally straight channels disposed in said second structure contact surface,
wherein said first flat contact surface of said first structure is configured to removably engage said second structure contact surface;
wherein said two or more channels disposed in said second structure and said first structure contact surface form two or more passageways therethrough;
wherein a first passageway of said two or more passageways is further configured to enable the fishing line to slide therethrough; and
wherein a second passageway of said two or more passageways is further configured having a friction material positioned therein to prevent the fishing line from sliding therethrough.

17. The weight assembly of claim 16, wherein said first structure contact surface abuts said second structure contact surface.

18. The weight assembly of claim 16, wherein said first structure contact surface abuts said second structure contact surface to form two or more passageways therethrough.

19. The weight assembly of claim 16, wherein said first structure and said second structure are releasably affixed one to the other.

20. The weight assembly of claim 19, wherein said releasably affixed further comprises magnetic forces.

21. The weight assembly of claim 16, wherein said first structure contact surface and said two or more channels disposed in said second structure contact surface are releasably displaced apart along an axial plane.

22. The weight assembly of claim 16, wherein one of said two or more passageways is further configured to enable the fishing line to slide therethrough.

23. (canceled)

24. The weight assembly of claim 16, wherein said friction material is selected from a group consisting of silicone, polymer, rubber and combinations thereof.

25. The weight assembly of claim 16, wherein said first structure and said second structure releasably affix one to the other via a magnetic force therebetween.

26. The weight assembly of claim 25, wherein said magnetic force is configured to releasably affix said first structure to said second structure in a fixed position on the fishing line.

27. The weight assembly of claim 26, wherein said second passageway and said friction material positioned therein are configured to releasably affix the fishing line therein.

28. The weight assembly of claim 25, further comprises two or more disengagement tabs configured to provide leverage to separate said first structure from said second structure.

29. The weight assembly of claim 28, wherein said two or more disengagement tabs are disposed on an exterior surface of said first structure and said second structure.

30. A method of releasably affixing a weight to a fishing line, the method comprising the steps of:
providing a weight assembly that further comprises a first structure having a first structure contact surface, said first structure contact surface formed having a first set of two or more longitudinally straight channels disposed in said first structure contact surface, a second structure having a second structure contact surface, said second structure contact surface formed having a second set of two or more longitudinally straight channels disposed in said second structure contact surface, wherein said first structure contact surface of said first structure is configured to removeably engage said second structure contact surface, wherein said first set of two or more channels disposed in said first structure contact surface and said second set of two or more channels disposed in said second structure contact surface are aligned to form two or more passageways therethrough, wherein a first passageway of said two or more passageways is further configured to enable the fishing line to slide therethrough, and wherein a second passageway of said two or more passageways is further configured having a friction material positioned therein to prevent the fishing line from sliding therethrough;
positioning the fishing line within one of said two or more passageways;
aligning said first set of two or more channels with said second set of two or more channels; and
positioning said first structure contact surface of said a first structure in close proximity to said second structure contact surface of said second structure, wherein said first structure is releasably affixed to said second structure in a fixed position on the fishing line.

31. The method of claim 30, further comprising the step of utilizing said weight assembly as a slip sinker.

32. The method of claim 30, further comprising the step of utilizing said weight assembly as a fixed sinker.

33. The method of claim 30, further comprising the step of removing said weight assembly from the fishing line.

34. The method of claim 33, further comprising the step of utilizing a disengagement tab to remove said weight assembly from the fishing line.

35. The method of claim 33, further comprising the step of repositioning said weight assembly to a new position on the fishing line.
